(19) United States
(12) Patent Application Publication
(10) Pub. No.: US 2003/0138671 A1
(43) Pub. Date: Jul. 24, 2003

(54) Longitudinal magnetic recording medium and a method for manufacturing the same

(75) Inventors: Tadaaki Oikawa, Nagano (JP); Takahiro Shimizu, Nagano (JP); Hiroyuki Uwazumi, Nagano (JP); Naoki Takizawa, Nagano (JP); Miyabi Nakamura, Ibaragi (JP)

Correspondence Address: STAAS & HALSEY LLP, 700 11TH STREET, NW, SUITE 500, WASHINGTON, DC, 20001, US

(73) Assignee: Fuji Electric Co., Ltd., Kawasaki (JP)

(21) Appl. No.: 10/317,221

(22) Filed: Dec. 12, 2002

(30) Foreign Application Priority Data
Dec. 12, 2001 (JP) 2001-379143

(51) Int. Cl. G11B 5/72

(52) U.S. Cl. 428/695; 428/694 TS; 428/694 DE

(57) ABSTRACT

In a longitudinal magnetic recording medium and a method to manufacture the medium, employing a granular magnetic layer minimizes magnetic particles, resistance to thermal fluctuation is superior, and as a result, SNR is enhanced. The longitudinal magnetic recording medium includes a nonmagnetic underlayer, a nonmagnetic intermediate layer, a magnetic stabilizing layer, a nonmagnetic metallic spacer layer, a magnetic layer, a protective film layer, and a liquid lubricant layer, which are sequentially laminated on a nonmagnetic substrate. The magnetic layer has a granular structure including ferromagnetic crystal grains with a hexagonal closest packed structure and a nonmagnetic grain boundary region surrounding the grains and including an oxide. The stabilizing layer and the magnetic layer are antiferromagnetically coupled to one another through the spacer layer.

### CROSS-REFERENCE TO RELATED APPLICATIONS

This application claims the priority of Japan Patent Application No. 2001-379143, filed Dec. 12, 2001 in the Japanese Intellectual Property Office, the disclosure of which is incorporated herein by reference.

### BACKGROUND OF THE INVENTION

1. Field of the Invention

The present invention relates to a longitudinal magnetic recording medium mounted on a variety of magnetic recording devices such as an external memory device of a computer. The invention also relates to a method to manufacture the magnetic recording medium.

2. Description of the Related Art

A demand for a high recording density of a longitudinal magnetic recording medium is increasing at a remarkable rate. The demands are quite unlikely to slow down. However, there are some problems in achieving the high recording density. One of the problems is enhancement of a signal to noise ratio, SNR. Reduction of media noise through isolation and size reduction of magnetic particles is effective in the SNR enhancement. Techniques to reduce the media noise have been proposed including a selection of appropriate composition of an underlayer and a magnetic layer, controlling of conditions to deposit each layer, and a multiplication or a decrease of thickness of the underlayer and magnetic layer. Recently, the magnetic layer generally called a granular magnetic layer has been proposed for an approach to the SNR reduction. The granular magnetic layer has a structure in which each ferromagnetic crystal grain is surrounded by a nonmagnetic nonmetallic substance, such as oxide or nitride.

Japanese Unexamined Patent Application Publication 8-255342, for example, discloses noise reduction by providing the granular recording layer in which ferromagnetic crystal grains are dispersed in the nonmagnetic film, the recording layer being formed by executing a heat treatment after sequentially laminating the nonmagnetic film, a ferromagnetic film, and nonmagnetic film. In this case, the nonmagnetic film is an oxide or a nitride of silicon. U.S. Patent No. 5,679,473 discloses that the noise reduction can be achieved by providing a granular recording film having a structure in which each of the magnetic crystal grains are surrounded and separated by a nonmagnetic oxide region. The granular recording film can be formed by an RF sputtering using a CoNiPt target containing oxide, such as SiO₂.

Because a nonmagnetic nonmetallic grain boundary phase physically separates each magnetic particle in the granular magnetic layer, a magnetic interaction acting between magnetic particles decreases and a zigzag-shaped magnetic domain wall is suppressed to develop in a transition region of a recording bit. As a result, a low noise characteristic is attained. In a conventionally used metallic magnetic film of a CoCr system, chromium segregates from a magnetic particle of cobalt system and precipitates at a grain boundary by deposition at a high temperature, to thereby reduce a magnetic interaction between the magnetic particles. The granular magnetic layer has an advantage of easily promoting isolation of magnetic particles because the grain boundary phase of the granular magnetic layer uses nonmagnetic nonmetallic substance, which segregates easier than conventional chromium. Raising a temperature of a substrate to at least 200° is indispensable in the deposition process of the conventional metallic magnetic layer of the CoCr system to segregate enough chromium. In contrast, the granular magnetic layer also has the advantage that the nonmagnetic metallic substance segregates even in a deposition process without heating as in the case with heating.

In addition to decreasing the magnetic interaction between particles by virtue of promoting the segregation structure in the magnetic layer, enhancement of the recording density and the noise reduction in the longitudinal magnetic recording medium also require control of a crystal alignment of the ferromagnetic crystal grain of the CoCr system, that is, an in-plane alignment of a c-axis of the ferromagnetic crystal grains having hexagonal closest packed structure. Consequently, control of crystal alignment in the conventional metallic magnetic layer has been performed by controlling a structure and a crystal alignment of a nonmagnetic underlayer.

On the other hand, an effect of the nonmagnetic underlayer has been assumed little in a longitudinal magnetic recording medium having the granular magnetic film, because the nonmagnetic underlayer is separated from the ferromagnetic crystal grains by oxide or other types of grain boundary segregation substances. However, Journal of the Magnetics Society of Japan vol. 23, no. 4-2, p 1021 (1999) describes that (100) plane and (101) plane of the ferromagnetic crystal grain are predominantly aligned in the granular magnetic layer by using an underlayer of CrMo alloy with a special composition having a predominantly aligned (110) plane, leading to improvement in magnetic characteristics and electromagnetic conversion characteristics.

### SUMMARY OF THE INVENTION

Various aspects and advantages of the invention will be set forth in part in the description that follows and, in part, will be obvious from the description, or may be learned by practice of the invention.

Minimization of a particle size of magnetic particles is indispensable to achieve an SNR enhancement accompanied by a high recording density. Minimization of a particle size may be easily attained in a granular magnetic layer than in a conventional magnetic layer of a CoCrPt system when a structure of a medium has a usual layer structure that does not utilize antiferromagnetic coupling and includes a nonmagnetic underlayer, a nonmagnetic intermediate layer, a magnetic layer, a protective film layer, and a liquid lubricant layer. However, a coercive force Hc of the medium decreases with a minimization of magnetic particles, which is considered to arise due to a thermal fluctuation of magnetization, in which thermal energy around the magnetic particles increases as size of the particles decreases. When an effect of the thermal fluctuation increases, decay of a recording signal becomes noticeable, which reduces the coercive force Hc of the medium. Thus, the high recording density is hardly compatible with a resistance to the thermal fluctuation.

Therefore, it has been demanded to produce a longitudinal magnetic recording medium with minute magnetic particles and superior resistance to the thermal fluctuation. More specifically, the desired longitudinal magnetic recording medium exhibits improved SNR resulting from minute magnetic particles obtained by employing a granular magnetic layer and a superior resistance to the thermal fluctuation.

A conventional production process of the longitudinal magnetic recording medium needs a step of preheating the nonmagnetic substrate. But, a production method without the heating step is desired to reduce a manufacturing cost.

Therefore, according to an aspect of the present invention, there is provided a longitudinal magnetic recording medium with high SNR that exhibits superior resistance to a thermal fluctuation despite minute magnetic particles obtained by a granular magnetic layer. The resistance to the thermal fluctuation is ensured by a medium structure that utilizes an antiferromagnetic coupling. Media noise is reduced by achieving the minute magnetic particles employing the granular magnetic layer.

Another aspect of the present invention is to provide a method to manufacture a longitudinal magnetic recording medium that exhibits high SNR and does not need heating.

According to an aspect of the present invention, there is provided a longitudinal magnetic recording medium that includes a nonmagnetic substrate and layers sequentially laminated on the substrate including a nonmagnetic underlayer, a nonmagnetic intermediate layer, a pair of a magnetic stabilizing layer and a nonmagnetic metallic spacer layer, a granular magnetic layer, a protective film layer, and a liquid lubricant layer. The magnetic layer of the longitudinal magnetic recording medium according to an aspect of the present invention has a granular structure including ferromagnetic crystal grains with a hexagonal closest packed structure and a nonmagnetic grain boundary region mainly of oxide surrounding the grains. The magnetic layer is antiferromagnetically coupled with the stabilizing layer through the spacer layer.

The magnetic underlayer may include a metal including W, Mo, and/or V, or an alloy containing 10 at % to 60 at % of Ti and a metal including W, Mo, Cr, or V. The nonmagnetic intermediate layer may include a metal including Ru, Ir, Rh, and/or Re, or an alloy containing 10 at % to 60 at % of Ti, C, W, Mo, or Cu and a metal including Ru, Ir, Rh, and Re

The stabilizing layer may include an alloy containing mainly cobalt and at least an additive of Cr, Ta, Pt, B, or Cu. Alternatively, the stabilizing layer may include ferromagnetic grains and a nonmagnetic grain boundary region of an oxide or a nitride including Cr, Co, Si, Al, Ti, Ta, Hf, and/or Zr. The stabilizing layer may have a coercive force Hc smaller than, Hc of the magnetic layer that is disposed on the spacer layer.

A material for the spacer layer may include Ru, Re, and/or Os, or an alloy including Ru, Re, and Os. The material for the spacer layer may have a hexagonal crystal structure. A thickness of the spacer layer may be in a range from 0.5 nm to 2.0 nm.

The nonmagnetic grain boundary region in the magnetic layer includes an oxide or a nitride including Cr, Co, Si, Al, Ti, Ta, Hf, and/or Zr.

The nonmagnetic substrate may be made of crystallized glass, chemically strengthened glass, or a plastic resin.

According to an aspect of the present invention, there is provided a method to manufacture a longitudinal magnetic recording medium described above. The method of the invention does not need to preheat the nonmagnetic substrate.

These together with other aspects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and other aspects and advantages of the invention will become apparent and more readily appreciated from the following description of the embodiments, taken in conjunction with the accompanying drawings of which:

FIG. 1(a) is a schematic cross-sectional view of a longitudinal magnetic recording medium, according to an aspect of the present invention.

FIG. 1(b) is a schematic cross-sectional view of a conventional longitudinal magnetic recording medium.

FIG. 2(a) is a chart showing an M-H loop of Comparative Example 3 that has a conventional layer structure.

FIG. 2(b) is a chart showing an M-H loop of Example 1 that uses an antiferromagnetic coupling, according to an aspect of the present invention.

FIG. 3 is a graph showing a dependence of a product of a residual magnetic flux density and a film thickness Br*δ of a thickness of a spacer layer.

FIG. 4 is a graph showing dependence of Br*δ of a thickness of a stabilizing layer.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

According to an aspect of the present application, there is a provided a longitudinal magnetic recording medium that includes a nonmagnetic substrate and layers laminated on a substrate including a nonmagnetic underlayer, a nonmagnetic intermediate layer, a pair of magnetic stabilizing layers and a nonmagnetic metallic spacer layer, a granular magnetic layer, a protective film layer, and a liquid lubricant layer. The magnetic layer has a granular structure including of ferromagnetic grains with a hexagonal closest packed structure and a nonmagnetic grain boundary region including mainly of an oxide surrounding the ferromagnetic grains. The magnetic layer is antiferromagnetically coupled with the stabilizing layer through the spacer layer.

When the spacer layer with a suitable thickness and the stabilizing layer with a proper magnetic characteristic are provided under the magnetic layer, an antiferromagnetic coupling can be induced between the magnetic layer and the stabilizing layer which are separated by the spacer layer. The antiferromagnetic coupling is said to arise from an RKKY interaction (Ruderman-Kittel, Kasuya, Yoshida interaction). A magnitude of the interaction is represented by a damping oscillation function of a thickness of the spacer layer. That is, the antiferromagnetic coupling occurs only in a limited range of the spacer layer thickness.

The magnetization of portions that are antiferromagnetically coupled through the spacer layer are in an antiparallel state to each other and are not observed macroscopically. Consequently, the magnetization involved in a magnetic recording characteristic such as an SNR is only carried by the magnetization of a portion that is not antiferromagnetically coupled. Specifically, the top layer of the magnetic layer or a portion within the magnetic layer is involved in the recording and regeneration of signals.

One of the indices to resistance to thermal fluctuation is a KuV/k_{B}T value, where Ku: anisotropy constant, V: volume of a magnetic particle, k_{B}: Bolzmann constant, and T: absolute temperature. KuV represents magnetic energy and k_{B}T represents thermal energy. Consequently, the KuV/k_{B}T value is a ratio of the magnetic energy to the thermal energy, and the larger the KuV/k_{B}T value is, the higher the resistance to the thermal fluctuation. Because the volume V in the KuV/k_{B}T value can be considered to incorporate a volume of the antiferromagnetically coupled portion, the KuV/k_{B}T value of the medium including an antiferromagnetically coupled structure has a large value, whereby a thermally stable longitudinal magnetic recording medium can be obtained.

In a conventional structure, the magnetic layer bears both functions of magnetic recording and resistance to the thermal fluctuation. In the medium of an aspect of the present invention, in contrast, the functions can be separately born by virtue of the antiferromagnetic coupling. Accordingly, a high recording density is compatible with the resistance to the thermal fluctuation in the medium, according to an aspect of the present invention.

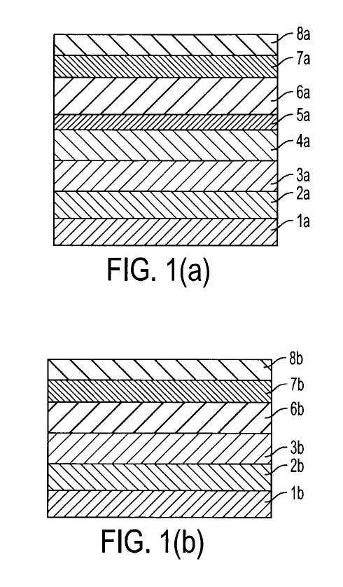

FIG. 1(a) is a schematic cross-sectional view of the longitudinal magnetic recording medium, according to an aspect of the present invention. FIG. 1(b) is a schematic cross-sectional view of a conventional longitudinal magnetic recording medium.

As shown in FIG. 1(a), the longitudinal magnetic recording medium, according to an aspect the present invention, has a structure in which a nonmagnetic underlayer 2a, a nonmagnetic intermediate layer 3a, a stabilizing layer 4a, a spacer layer 5a, a granular magnetic layer 6a, and a protective film layer 7a are sequentially laminated on a nonmagnetic substrate 1a. On the protective film layer 7a, a liquid lubricant layer 8a is formed. On the other hand, the conventional longitudinal magnetic recording medium (FIG. 1(b)) has a structure in which a nonmagnetic underlayer 2b, a nonmagnetic intermediate layer 3b, a granular magnetic layer 6b, a protective film layer 7b, and a liquid lubricant layer 8b are sequentially formed on a nonmagnetic substrate 1b, and do not include the stabilizing layer 4a and the spacer layer 5a that are included in the longitudinal magnetic recording medium of an aspect of the present invention shown in FIG. 1(a).

The nonmagnetic substrate la may include a NiP-plated aluminum alloy, a strengthened glass, or a crystallized glass, which are typically used in the magnetic recording medium for longitudinal recording. Because substrate heating is unnecessary, a substrate made by injection molding polycarbonate, polyolefin, or another resin can also be used. The protective film layer 7a is a thin film of mainly carbon, for example. The liquid lubricant layer 8a is made of perfluoropolyether lubricant, for example.

The magnetic layer 6a is a granular magnetic layer including ferromagnetic crystal grains and a nonmagnetic grain boundary region surrounding the grains, the grain boundary region including oxide or nitride metal. Such granular structure can be formed using, for example, a sputtering method using a target of ferromagnetic alloy containing an oxide constituting the nonmagnetic grain boundary region.

An alloy of a CoPt system may be used for a material composing the ferromagnetic crystal grains, though not limited to a special material. In order to form a stable granular structure, an oxide may be used of an element from Cr, Co, Si, Al, Ti, Ta, Hf, or Zr for the grain boundary region in combination with the ferromagnetic crystal grains of the CoPt alloy. The magnetic layer needs to have a thickness that is necessary and sufficient to produce enough strength of head regeneration output.

The nonmagnetic underlayer 2a needs to have a body-centered cubic (bcc) structure and the dominant crystal alignment plane of the underlayer is necessarily the (200) plane, because lattice misfit with respect to the nonmagnetic intermediate layer or the magnetic layer can be reduced. For instance, a material for the underlayer includes a metal being W, Mo, and/or V, or an alloy having 10 at % to 60 at % of Ti and a metal being W, Mo, Cr, or V.

Even if 10 at % to 60 at % of Ti, which has the hexagonal closest packed structure, is contained in W, Mo, Cr, or V, which has a body-centered cubic structure, the body-centered cubic structure is retained and the alignment inherent to the hexagonal closest packed structure does not appear. The predominant (200) alignment of the body-centered cubic structure arises more effectively and the lattice constant with a small misfit to the nonmagnetic intermediate layer or the magnetic layer is obtained. A thickness of the nonmagnetic underlayer may be from 5 nm to 100 nm.

The nonmagnetic intermediate layer 3a may have the hexagonal closest packed structure, which is the same as the structure of the ferromagnetic crystal grains in the magnetic layer. A material for the intermediate layer may include Ru, Ir, Rh, Re, and an alloy of Ru, Ir, Rh, or Re each containing 10 at % to 60 at % of Ti, C, W, Mo, or Cu. A thickness of the intermediate layer may be in a range from 2 nm to 50 nm.

The stabilizing layer 4a, which is featured by the layer structure, according to an aspect of the present invention, may include an alloy of mainly Co with an appropriate addition of Cr, Ta, Pt, B, and/or Cu. The stabilizing layer can alternatively include ferromagnetic grains and an oxide or a nitride being Cr, Co, Si, Al, Ti, Ta, Hf, and/or Zr. A thickness of the stabilizing layer is confined in a range such that the coercive force Hc of the stabilizing layer is smaller than the Hc of the magnetic layer disposed on the spacer layer 5a, so that the range may be from 2 nm to 10 nm.

The material for the spacer layer 5a may have a hexagonal crystal structure including Ru, Re, Os, or alloys each containing at least one element being Ru, Re, and Os. The thickness may be in a range of from 0.5 nm to 2.0 nm.

Next, a second aspect of the present invention is described.

The second aspect, according to the present invention, is a method to manufacture the longitudinal magnetic recording medium that is described above and shown in FIG. 1(a). The method, according to an aspect of the present invention, allows omitting a substrate heating step, which is essential in conventional methods.

Manufacturing of the longitudinal magnetic recording medium, according to an aspect of the method of the present invention, can be conducted using a conventional RF sputtering apparatus, for example.

Specifically a substrate is introduced into the apparatus. A target of a predetermined material is mounted and argon gas pressure in the apparatus is adjusted to an appropriate value. Power is supplied to an electrode to deposit an underlayer. In the same manner as in the case of the underlayer described above, an intermediate layer, a stabilizing layer, a spacer layer, a granular magnetic layer, and a protective film layer, are laminated and are successively provided to a target having a composition. Here, deposition of the granular magnetic layer containing oxide is conducted using an RF power supply. Finally, a liquid lubricant is applied to complete the longitudinal magnetic recording medium.

According to another aspect of the method, the longitudinal magnetic recording medium exhibiting high Hc and low media noise can be obtained if heating of the substrate is omitted, the heating being essential in a method to manufacture the conventional type longitudinal magnetic recording medium. As a result, simplification of the manufacturing process and reduction of manufacturing cost can be achieved.

Some specific examples of aspects of the present invention are described hereafter.

### EXAMPLE 1

A chemically strengthened glass substrate N-10 manufactured by HOYA Corporation, may be used for the nonmagnetic substrate. After cleaning, the substrate is introduced into the sputtering apparatus, and the underlayer 2a of tungsten 30 nm thick is formed under an argon gas pressure of 15 mTorr (2.0 Pa). Subsequently, the intermediate layer 3a of ruthenium 10 nm thick is formed under the argon gas pressure of 15 mTorr (2.0 Pa); the stabilizing layer of 4a Co₈₃Cr₁₃Ta₄ with a thickness of 5 nm is formed under the argon gas pressure of 15 mTorr (2.0 Pa); and the spacer layer 5a of ruthenium 1.0 nm thick is formed under the argon gas pressure of 15 mTorr (2.0 Pa). The granular magnetic layer 6a is 15 nm thick and is formed by an RF sputtering method using a target of Co₇₆Cr₁₀Pt₁₄ containing 7 mol % of SiO₂ under an argon gas pressure of 30 mTorr (4.0 Pa). After laminating a carbon protective film layer being 10 nm thick, the laminated substrate is taken out from the vacuum chamber. Applying a liquid lubricant to the thickness of 1.5 nm, the longitudinal magnetic recording medium having the layer structure as shown in FIG. 1(a) is produced. In the foregoing manufacturing process, the heating of the substrate before laminating process is not executed.

### EXAMPLE 2

The longitudinal magnetic recording medium is produced using the same compositions and deposition processes as in Example 1 except that the stabilizing layer is the granular magnetic layer 6a of 5 nm thick formed by the RF sputtering method using a target of Co₈₈Cr₁₀Pt₁₂ containing 6 mol % of SiO₂ under the argon gas pressure of 30 mTorr (4.0 Pa).

### Comparative Example 1

A medium of Comparative Example 1 has the layer structure, according to an aspect of the present invention, but the magnetic layer is not a granular magnetic layer. The longitudinal magnetic recording medium of the Comparative Example 1 is produced using the same compositions and deposition processes as in Example 1 except that the magnetic layer is 15 nm thick and is formed by a DC sputtering method using a target of Co₆₄Cr₂₂Pt₁₀B₄ under the argon gas pressure of 30 mTorr (4.0 Pa).

### Comparative Example 2

A medium of Comparative Example 2 has the conventional layer structure and the magnetic layer is not the granular magnetic layer. The longitudinal magnetic recording medium of the Comparative Example 1 is produced forming an underlayer, an intermediate layer, a carbon protective film layer, and a liquid lubricant layer in the same deposition conditions and film thickness as in Example 1. The magnetic layer in the medium of Comparative Example 2 is formed to a thickness of 15 nm of Co₆₄Cr₂₂Pt₁₀B₄ under the argon gas pressure of 30 mTorr (4.0 Pa).

### Comparative Example 3

A medium of Comparative Example 3 has the granular magnetic layer, but the layer structure is a conventional one. The longitudinal magnetic recording medium of the Comparative Example 3 is produced using the same compositions and deposition processes as in the Comparative Example 2 except that the magnetic layer that is the granular magnetic layer 5 nm thick is formed by the RF sputtering method using a target of Co₇₆Cr₁₀Pt₁₄ containing 7 mol % of SiO₂ under the argon gas pressure of 30 mTorr (4.0 Pa).

### Evaluation

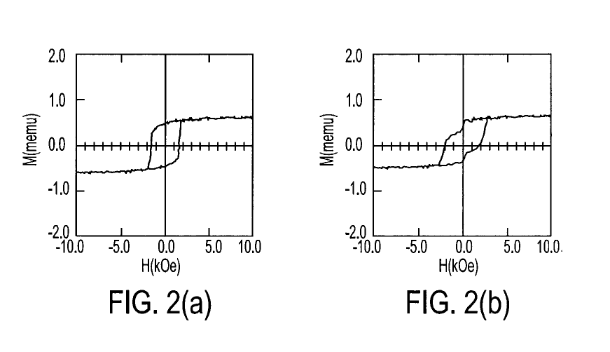

FIG. 2(a) is a chart showing an M-H loop of the Comparative Example 3 that has the conventional layer structure; and FIG. 2(b) is a chart showing an M-H loop of Example 1 that uses the antiferromagnetic coupling, according to an aspect of the present invention. Measurement is done using a vibrating sample magnetometer (VSM). The hysteresis loop of the medium provided with the stabilizing layer and the spacer layer show a step-like drop of magnetization around a zero external magnetic field as observed in FIG. 1(b), which is a noticeable characteristic that is not observed in a hysteresis loop of a medium with the conventional structure shown in FIG. 2(a).

A drop of the magnetization indicates existence of the antiferromagnetic coupling within the medium. The magnitude of the drop of the magnetization depends on the film thickness and the magnetic properties of the stabilizing layer and the magnetic layer, and is not restricted by the above aspects of the present invention.

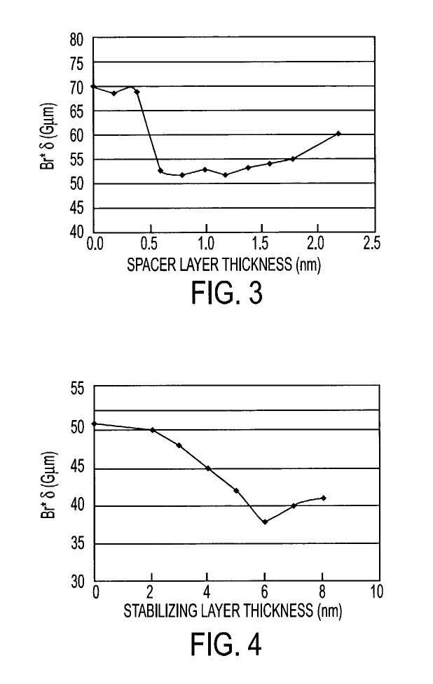

FIG. 3 shows a dependence of the product of residual magnetic flux density and film thickness: Br*δ on a thickness of the spacer layer for the medium of Example 2. The measurement is made using the VSM. FIG. 3 shows that the Br*δ does not change in the thickness range up to 0.4 nm, while an abrupt drop is observed around 0.5 nm. In a range from 0.6 nm to 1.8 nm the Br*δ is substantially constant and gradually increases, which suggests that the antiferromagnetic coupling occurs in a limited range of the spacer layer thickness, and the coupling is weak outside the range. According to Example 2, the spacer layer thickness may be in a range from 0.5 nm to 2.0 nm to set up the antiferromagnetic coupling.

FIG. 4 shows a dependence of the Br*δ on the thickness of the stabilizing layer. Measurement is made using the VSM. FIG. 4 indicates that the Br*δ decreases with an increase of the stabilizing layer thickness, while beyond certain thickness, the Br*δ increases. That is, the reduction of the Br*δ by virtue of the antiferromagnetic coupling increases with an increase of the stabilizing layer thickness, while beyond certain thickness, the coupling becomes weak and the reduction of the Br*δ decreases. The reduction in the Br*δ is at a maximum at the stabilizing layer thickness of 6.0 nm, for instance. However, the reduction in the Br*δ varies depending on the composition and thickness of the stabilizing layer and the magnetic layer, and no restriction is posed, according to aspects of the present invention.

Table 1 illustrates a coercive force Hc (Oe), an average of a grain size in the magnetic layer (nm), a KuV/k_{B}T value that is an index to the thermal fluctuation, and electromagnetic conversion characteristics including normalized noise (μVrms/mVpp) and the SNR (dB) for the Examples and Comparative Examples. The KuV/k_{B}T value is measured by the VSM, and the electromagnetic conversion characteristics are measured by a spinning stand tester equipped with a GMR head.

TABLE 1

| | Hc | Grain size | | Normalized noise | SNR |
|---|---|---|---|---|---|
| Sample | [Oe] | [nm] (*) | KuV/k_{B}T | [μVrms/mVpp] | [dB] |
| Example 1 | 3,873 | 6.92 | 94 | 36.8 | 22.5 |
| Example 2 | 4,142 | 5.11 | 83 | 31.9 | 24.5 |
| Comp Ex 1 | 3,642 | 8.01 | 101 | 37.1 | 21.6 |
| Comp Ex 2 | 3,083 | 7.83 | 76 | 38.4 | 21.1 |
| Comp Ex 3 | 3,742 | 6.08 | 62 | 36.2 | 22.7 |

(*) mean grain size in the magnetic layer

Concerning the Hc, the medium (Comparative Example 1) having the magnetic layer of the Co₆₄Cr₂₂Pt₁₀B₄ that is a composition of the CoCrPt alloy system with a nongranular structure exhibit a smaller value of Hc than Example 1 having the granular magnetic layer, which can be attributed to a difference in platinum content in the magnetic layer. Observing the grain sizes in the magnetic layer of the Examples and Comparative Examples, finer grain sizes are noticeable in Examples 1 and 2, and Comparative Example 3 that use a granular film for the magnetic layer. Comparing Comparative Example 2 and Comparative Example 3, both have a layer structure of the conventional longitudinal magnetic recording medium, the use of the granular magnetic layer for the magnetic layer has brought about enhancement of the Hc by optimizing of the composition and reduction of noises, that is enhancement of the SNR, by promoting the grain size reduction in the magnetic layer.

Next, the KuV/k_{B}T value is considered.

It is generally considered that the thermal fluctuation is not problematic if the KuV/k_{B}T value is at least 60. In Comparative Example 3 that uses a granular magnetic layer for the magnetic layer, although noises are reduced by the decrease of the grain size in the magnetic layer, the KuV/k_{B}T value is reduced to the value of 62 due to the decrease of the grain size, which indicates that further decrease of the grain size provides lower noises required by the higher recording density and makes the problem of thermal fluctuation serious if the granular structure is employed in the conventional layer structure of the medium.

Comparative Example 2 using the CoCrPt alloy without an oxide for the magnetic layer has a slightly larger grain size than Comparative Example 3 and exhibits the KuV/k_{B}T value of 76, which is not very small. However, an influence of the thermal fluctuation becomes significant when the recording density is further raised, which is a similar situation to the above-mentioned case of the granular magnetic layer.

Examples 1 and 2 and Comparative Example 1 that include the stabilizing layer and the spacer layer, according to an aspect of the present invention, exhibits larger KuV/k_{B}T values than Comparative Examples 2 and 3, whereby thermal stability is improved.

Regarding the electromagnetic conversion characteristics, Example 1 has a stabilizing layer of a CoCr alloy without the oxide and the magnetic layer of the granular magnetic layer and exhibits the larger KuV/k_{B}T value than Example 2, and larger grain size exists in the magnetic layer based on the difference in the composition. The SNR is not improved as compared with Comparative Example 3. In contrast to the Example 1, in the Example 2, in which both the stabilizing and magnetic layers include the granular composition, enhancement of the KuV/k_{B}T value is compatible with improvement of the SNR by virtue of the fine grain size, and the largest effect that has been demonstrated.

Because the structure with the fine grain size can be readily obtained in the granular magnetic layer compared to the conventional magnetic layer of the CoCr alloy, an effect according to an aspect of the present invention is largest when the stabilizing layer includes the granular film with the optimized composition and the magnetic layer also includes the granular magnetic layer.

Reduction of the mean grain size in the magnetic layer can be accomplished by optimization of the thickness of the nonmagnetic underlayer and other means, even when the stabilizing layer includes an alloy of the CoCr system. Accordingly, resistance to thermal fluctuation can be compatible with reduction of noises also in the combination of the stabilizing layer of the CoCr alloy and the granular magnetic layer.

As described above, the stabilizing layer and the spacer layer are provided in the longitudinal magnetic recording medium, and the thickness of the stabilizing layer and the spacer layer are optimized. In this structure, according to an aspect of the present invention, antiferromagnetic coupling is induced between the stabilizing layer and the magnetic layer through the spacer layer. As a result, resistance to thermal fluctuation is raised, which brings about fine magnetic particles that were conventionally impossible, resulting in the high SNR and leading to the enhanced recording density.

Because excellent characteristics can be readily obtained by employing the layer structure, according to an aspect of the present invention, substrate heating is unnecessary in the process of laminating the medium of the present invention. Accordingly, inexpensive plastic can be used for the substrate as well as conventional aluminum and glass substrates.

A medium including a stabilizing layer, a spacer layer, and a granular magnetic layer, according to an aspect of the present invention, provides resistance to thermal fluctuation that is compatible with noise reduction by virtue of a fine grain size.

When a composition and a film thickness of the spacer layer, the stabilizing layer, and the magnetic layer, and deposition conditions for these layers are optimized, an antiferromagnetic coupling arises between the stabilizing layer and the magnetic layer, where resistance to a thermal fluctuation is ascertained. Consequently, noise reduction, which means an SNR enhancement, can be accomplished by employing fine magnetic particles, use of which is impossible in conventional media due to a significant influence of the thermal fluctuation in a conventional layer structure.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A longitudinal magnetic recording medium, comprising:
a nonmagnetic substrate;
a nonmagnetic underlayer;
a nonmagnetic intermediate layer;
a magnetic stabilizing layer;
a nonmagnetic metallic spacer layer;
a magnetic layer having a granular structure that comprises ferromagnetic crystal grains with a hexagonal closest packed structure and a nonmagnetic grain boundary region comprising an oxide surrounding the grains;
a protective film layer; and
a liquid lubricant layer, wherein
the stabilizing layer and magnetic layer are antiferromagnetically coupled through the spacer layer, and the underlayer, the intermediate layer, the stabilizing layer, the magnetic layer, the film layer and the lubricant layer are sequentially laminated on the substrate.

2. The longitudinal magnetic recording medium as recited in claim 1, wherein the underlayer comprises W, Mo, V, or alloys each having 10 at % to 60 at % of Ti and a metal comprising W, Mo, Cr, or V.

3. The longitudinal magnetic recording medium as recited in claim 2, wherein the intermediate layer comprises Ru, Ir, Rh, Re, or alloys each having 10 at % to 60 at % of Ti, C, W, Mo, or Cu and a metal comprising Ru, Ir, Rh, or Re.

4. The longitudinal magnetic recording medium as recited in claim 2, wherein the stabilizing layer comprises an alloy having Co added with Cr, Ta, Pt, B, and/or Cu, or a granular structure having ferromagnetic crystal grains and an oxide or a nitride comprising Cr, Co, Si, Al, Ti, Ta, Hf, and/or Zr, and a coercive force Hc of the stabilizing layer is smaller than the coercive force Hc of the magnetic layer disposed on the spacer layer.

5. The longitudinal magnetic recording medium as recited in claim 2, wherein a material of the spacer layer comprises Ru, Re, Os, or alloys each having Ru, Re, and/or Os, and the space layer has a hexagonal closest packed structure, and the spacer layer has a thickness from 0.5 nm to 2.0 nm.

6. The longitudinal magnetic recording medium as recited in claim 2, wherein the grain boundary region in the magnetic layer comprises an oxide having Cr, Co, Si, Al, Ti, Ta, Hf, and/or Zr.

7. The longitudinal magnetic recording medium as recited in claim 1, wherein the intermediate layer comprises Ru, Ir, Rh, Re, or alloys each having 10 at % to 60 at % of Ti, C, W, Mo, or Cu and a metal comprising Ru, Ir, Rh, or Re.

8. The longitudinal magnetic recording medium as recited in claim 3, wherein the stabilizing layer comprises an alloy having Co added with Cr, Ta, Pt, B, and/or Cu, or a granular structure having ferromagnetic crystal grains and an oxide or a nitride comprising Cr, Co, Si, Al, Ti, Ta, Hf, and/or Zr, and a coercive force Hc of the stabilizing layer is smaller than the coercive force Hc of the magnetic layer disposed on the spacer layer.

9. The longitudinal magnetic recording medium as recited in claim 3, wherein a material of the spacer layer comprises Ru, Re, Os, or alloys each having Ru, Re, and/or Os, and the space layer has a hexagonal closest packed structure, and the spacer layer has a thickness from 0.5 nm to 2.0 nm.

10. The longitudinal magnetic recording medium as recited in claim 3, wherein the grain boundary region in the magnetic layer comprises an oxide having Cr, Co, Si, Al, Ti, Ta, Hf, and/or Zr.

11. The longitudinal magnetic recording medium as recited in in claim 1, wherein the stabilizing layer comprises an alloy having Co added with Cr, Ta, Pt, B, and/or Cu, or a granular structure having ferromagnetic crystal grains and an oxide or a nitride comprising Cr, Co, Si, Al, Ti, Ta, Hf, and/or Zr, and a coercive force Hc of the stabilizing layer is smaller than the coercive force Hc of the magnetic layer disposed on the spacer layer.

12. The longitudinal magnetic recording medium as recited in claim 4, wherein a material of the spacer layer comprises Ru, Re, Os, or alloys each having Ru, Re, and/or Os, and the space layer has a hexagonal closest packed structure, and the spacer layer has a thickness from 0.5 nm to 2.0 nm.

13. The longitudinal magnetic recording medium as recited in claim 4, wherein the grain boundary region in the magnetic layer comprises an oxide having Cr, Co, Si, Al, Ti, Ta, Hf, and/or Zr.

14. The longitudinal magnetic recording medium as recited in claim 1, wherein a material of the spacer layer comprises Ru, Re, Os, or alloys each having Ru, Re, and/or Os, and the space layer has a hexagonal closest packed structure, and the spacer layer has a thickness from 0.5 nm to 2.0 nm.

15. The longitudinal magnetic recording medium as recited in claim 5, wherein the grain boundary region in the magnetic layer comprises an oxide having Cr, Co, Si, Al, Ti, Ta, Hf, and/or Zr.

16. The longitudinal magnetic recording medium as recited in claim 1, wherein the grain boundary region in the magnetic layer comprises an oxide having Cr, Co, Si, Al, Ti, Ta, Hf, and/or Zr.

17. The longitudinal magnetic recording medium according to claim 1, wherein the substrate is made of a crystallized glass, a chemically strengthened glass, or a plastic resin.

18. A method of manufacturing a longitudinal magnetic recording medium, comprising a nonmagnetic substrate, a nonmagnetic underlayer, a nonmagnetic intermediate layer, a magnetic stabilizing layer, a nonmagnetic metallic spacer layer, a magnetic layer having a granular structure that comprises ferromagnetic crystal grains with a hexagonal closest packed structure and a nonmagnetic grain boundary region comprising an oxide surrounding the grains, a protective film layer, and a liquid lubricant layer, the method comprising:
sequentially laminating the underlayer, the intermediate layer, the stabilizing layer, the magnetic layer, the film layer, and the lubricant layer on the substrate; and
antiferromagnetically coupling the stabilizing layer and magnetic layer through the spacer layer.

19. The method as recited in claim 18, wherein deposition of the layers is conducted without preheating the substrate.
